(19) United States
(12) Patent Application Publication
(10) Pub. No.: US 2016/0006099 A1
(43) Pub. Date: Jan. 7, 2016

(54) WIDEBAND TRANSITION BETWEEN A PLANAR TRANSMISSION LINE AND A WAVEGUIDE

(71) Applicant: NEC CORPORATION, Tokyo (JP)

(72) Inventors: Taras KUSHTA, Tokyo (JP); Akira MIYATA, Tokyo (JP)

(73) Assignee: NEC CORPORATION, Tokyo (JP)

(21) Appl. No.: 14/769,663

(22) PCT Filed: Feb. 22, 2013
(86) PCT No.: PCT/JP2013/001030

§ 371 Date: Aug. 21, 2015

(51) Int. Cl. H01P 3/02

(52) U.S. Cl. CPC H01P 3/02

(57) ABSTRACT

A wideband transition of the present invention between a planar transmission line and a waveguide comprises a substrate, a segment of the planar transmission line, a conductive patch, an adjusting conductor plate and a section of the waveguide. The segment is arranged in a top conductor layer of the substrate. The conductive patch is arranged in the top conductor layer and connected to one end of the segment. The adjusting conductor plate is arranged in the top conductor layer or another conductor layer of the substrate next to the top conductor layer and isolated from any other conductor. The section is disposed above the conductive patch and connected to a conductor plane at the top conductor layer. Another end of the segment is a first terminal of the wideband transition. Another end of the section is a second terminal of the wideband transition.

### TECHNICAL FIELD

The present invention relates to a transition, disposed in a multilayer substrate, providing a low-loss signal transmission in a wide frequency band between a planar transmission line and a waveguide.

### BACKGROUND ART

It is a crucial problem providing transmittance of an electromagnetic wave between a microwave circuit element and an antenna with low return and insertion losses in a microwave (millimeter-wave) module in different practical applications, including automotive radar systems. Particularly, an appropriate transition between a planar transmission line connected to the microwave circuit element and a waveguide attached to the antenna can improve energy consumption in the systems.

In inventions U.S. Pat. No. 5,867,073, U.S. Pat. No. 6,127,901, U.S. 2008/0129408 and U.S. 2012/0050125, different structures of the transition between a planar transmission line and a waveguide are proposed.

However, development of the transition operating in a wide frequency band is vital for providing a low-cost microwave (millimeter-wave)module overcoming fabrication process tolerance problems.

### CITATION LIST

### Patent Literature

[PTL 1] U.S. Pat. No. 5,867,073

[PLT 2] U.S. Pat. No. 6,127,901

[PLT 3] U.S. Laid Open Patent Publication 2008/0129408

[PLT 4] U.S. Laid Open Patent Publication 2012/0050125

### SUMMARY OF INVENTION

It is an object of the present invention to form a wideband transition between a waveguide and a planar transmission line disposed in a multilayer substrate.

Here, such wideband transition is obtained by forming a matching structure near a conductive patch connected to the planar transmission line comprising a special adjusting plate.

### BRIEF DESCRIPTION OF DRAWINGS

[FIG. 1A]

FIG. 1A is a horizontal cross-section view of a wideband transition between a planar transmission line and a waveguide of an exemplary embodiment of the present invention on the section at a conductor layer 1L1 shown in FIG. 1B.

[FIG. 1B]

FIG. 1B is a vertical cross-sectional view of the wideband transition of the exemplary embodiment of the present invention shown in FIG. 1A on 1B-1B section.

[FIG. 1C]

FIG. 1C is another vertical cross-sectional view of the wideband transition of the exemplary embodiment of the present invention shown in FIG. 1A on 1C-1C section.

[FIG. 1D]

FIG. 1D is a horizontal cross-sectional view of the wideband transition of the exemplary embodiment of the present invention shown in FIG. 1A on the section at conductor layers 1L3 and 1L4.

[FIG. 1E]

FIG. 1E is a horizontal cross-sectional view of the wideband transition of the exemplary embodiment of the present invention shown in FIG. 1A on the section at conductor layer 1L2.

[FIG. 1F]

FIG. 1F is a top view of the wideband transition of the exemplary embodiment of the present invention shown in FIG. 1A.

[FIG. 1G]

FIG. 1G is a bottom view of the wideband transition of the exemplary embodiment of the present invention shown in FIG. 1A.

[FIG. 2A]

FIG. 2A is a horizontal cross-section view of a wideband transition between a planar transmission line and a waveguide of another exemplary embodiment of the present invention on the section at conductor layer 2L1 shown in FIG. 2B.

[FIG. 2B]

FIG. 2B is a vertical cross-sectional view of the wideband transition of another exemplary embodiment of the present invention shown in FIG. 2A on 2B-2B section.

[FIG. 2C]

FIG. 2C is a vertical cross-sectional view of the wideband transition of another exemplary embodiment of the present invention shown in FIG. 2A on 2C-2C section.

[FIG. 2D]

FIG. 2D is a horizontal cross-sectional view of the wideband transition of another exemplary embodiment of the present invention shown in FIG. 2A on the section at conductor layers 2L2, 2L3, 2L4, 2L5 and 2L6.

[FIG. 2E]

FIG. 2E is a top view of the wideband transition of another exemplary embodiment of the present invention shown in FIG. 2A.

[FIG. 3A]

FIG. 3A is a horizontal cross-section view of a wideband transition between a planar transmission line and a waveguide of further another exemplary embodiment of the present invention on the section at conductor layer 3L1 shown in FIG. 3B.

[FIG. 3B]

FIG. 3B is a vertical cross-sectional view of the wideband transition of further another exemplary embodiment of the present invention shown in FIG. 3A on 3B-3B section.

[FIG. 3C]

FIG. 3C is a vertical cross-sectional view of the wideband transition of further another exemplary embodiment of the present invention shown in FIG. 3A on 3C-3C section.

[FIG. 3D]

FIG. 3D is a horizontal cross-sectional view of the wideband transition of further another exemplary embodiment of the present invention shown in FIG. 3A on the section at conductor layer 3L2.

[FIG. 3E]

FIG. 3E is a horizontal cross-sectional view of the wideband transition of further another exemplary embodiment of the present invention shown in FIG. 3A on the section at conductor layer 3L3.

[FIG. 3F]

FIG. 3F is a horizontal cross-sectional view of the wideband transition of further another exemplary embodiment of the present invention shown in FIG. 3A on the section at conductor layer 3L4.

[FIG. 3G]

FIG. 3G is a top view of the wideband transition of further another exemplary embodiment of the present invention shown in FIG. 3A.

[FIG. 3H]

FIG. 3H is a bottom view of the wideband transition of further another exemplary embodiment of the present invention shown in FIG. 3A.

[FIG. 4A]

FIG. 4A is a horizontal cross-section view of a wideband transition between a planar transmission line and a waveguide of further another exemplary embodiment of the present invention on the section at conductor layer 4L1 shown in FIG. 4B.

[FIG. 4B]

FIG. 4B is a vertical cross-sectional view of the wideband transition of further another exemplary embodiment of the present invention shown in FIG. 4A on 4B-4B section.

[FIG. 4C]

FIG. 4C is a vertical cross-sectional view of the wideband transition of further another exemplary embodiment of the present invention shown in FIG. 4A on 4C-4C section.

[FIG. 4D]

FIG. 4D is a horizontal cross-sectional view of the wideband transition of further another exemplary embodiment of the present invention shown in FIG. 4A on the section at conductor layers 4L3 and 4L4.

[FIG. 4E]

FIG. 4E is a horizontal cross-sectional view of the wideband transition of further another exemplary embodiment of the present invention shown in FIG. 4A on the section at conductor layer 4L2.

[FIG. 4F]

FIG. 4F is a top view of the wideband transition of further another exemplary embodiment of the present invention shown in FIG. 4A.

[FIG. 4G]

FIG. 4G is a bottom view of the wideband transition of further another exemplary embodiment of the present invention shown in FIG. 4A.

[FIG. 5A]

FIG. 5A is a horizontal cross-section view of a wideband transition between a planar transmission line and a waveguide of further another exemplary embodiment of the present invention on the section at conductor layer 5L1 shown in FIG. 5B.

[FIG. 5B]

FIG. 5B is a vertical cross-sectional view of the wideband transition of further another exemplary embodiment of the present invention shown in FIG. 5A on 5B-5B section.

[FIG. 5C]

FIG. 5C is a vertical cross-sectional view of the wideband transition of further another exemplary embodiment of the present invention shown in FIG. 5A on 5C-5C section.

[FIG. 5D]

FIG. 5D is a horizontal cross-sectional view of the wideband transition of further another exemplary embodiment of the present invention shown in FIG. 5A on the section at conductor layers 5L2 and 5L3.

[FIG. 5E]

FIG. 5E is a top view of the wideband transition of further another exemplary embodiment of the present invention shown in FIG. 5A.

[FIG. 5F]

FIG. 5F is a bottom view of the wideband transition of further another exemplary embodiment of the present invention shown in FIG. 5A.

[FIG. 6A]

FIG. 6A is a horizontal cross-section view of a wideband transition between a planar transmission line and a waveguide of further another exemplary embodiment of the present invention on the section at conductor layer 6L1 shown in FIG. 6B.

[FIG. 6B]

FIG. 6B is a vertical cross-sectional view of the wideband transition of further another exemplary embodiment of the present invention shown in FIG. 6A on 6B-6B section.

[FIG. 6C]

FIG. 6C is a vertical cross-sectional view of the wideband transition of further another exemplary embodiment of the present invention shown in FIG. 6A on 6C-6C section.

[FIG. 6D]

FIG. 6D is a horizontal cross-sectional view of the wideband transition of further another exemplary embodiment of the present invention shown in FIG. 6A on the section at conductor layer 6L2.

[FIG. 6E]

FIG. 6E is a horizontal cross-sectional view of the wideband transition of further another exemplary embodiment of the present invention shown in FIG. 6A on the section at conductor layer 6L3.

[FIG. 6F]

FIG. 6F is a top view of the wideband transition of further another exemplary embodiment of the present invention shown in FIG. 6A.

[FIG. 6G]

FIG. 6G is a bottom view of the wideband transition of further another exemplary embodiment of the present invention shown in FIG. 6A.

[FIG. 7A]

FIG. 7A is a horizontal cross-section view of a wideband transition between a planar transmission line and a waveguide of further another exemplary embodiment of the present invention on the section at conductor layer 7L1 shown in FIG. 7B.

[FIG. 7B]

FIG. 7B is a vertical cross-sectional view of the wideband transition of further another exemplary embodiment of the present invention shown in FIG. 7A on 7B-7B section.

[FIG. 7C]

FIG. 7C is a vertical cross-sectional view of the wideband transition of further another exemplary embodiment of the present invention shown in FIG. 7A on 7C-7C section.

[FIG. 7D]

FIG. 7D is a horizontal cross-sectional view of the wideband transition of further another exemplary embodiment of the present invention shown in FIG. 7A on the section at conductor layers 7L2.

[FIG. 7E]

FIG. 7E is a horizontal cross-sectional view of the wideband transition of further another exemplary embodiment of the present invention shown in FIG. 7A on the section at conductor layers 7L3.

[FIG. 7F]

FIG. 7F is a top view of the wideband transition of further another exemplary embodiment of the present invention shown in FIG. 7A.

[FIG. 7G]

FIG. 7G is a bottom view of the wideband transition of further another exemplary embodiment of the present invention shown in FIG. 7A.

[FIG. 8]

FIG. 8 is a graph showing the effect of an adjusting plate on insertion losses of a transition.

### DESCRIPTION OF EXEMPLARY EMBODIMENTS

Hereinafter, several types of wideband transitions disposed in multilayer substrates between a planar transmission line and a waveguide according to the present invention will be described in details with reference to attached drawings. But, it would be well understood that this description should not be viewed as narrowing the appended claims.

### An Exemplary Embodiment

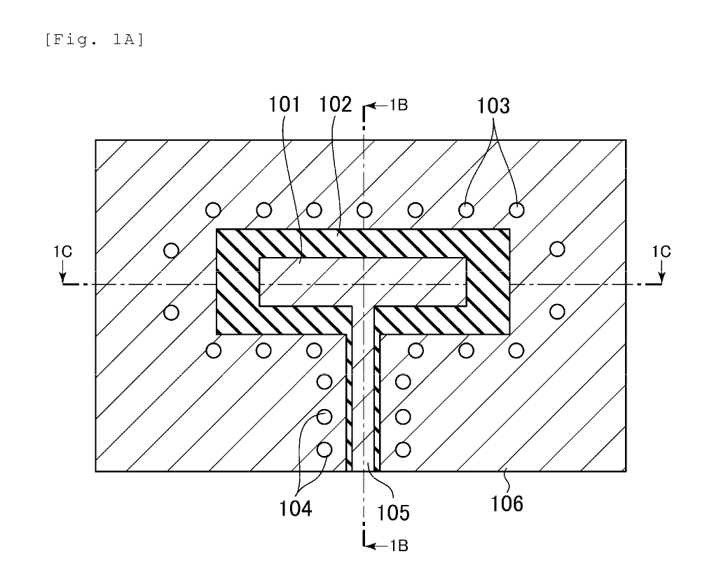

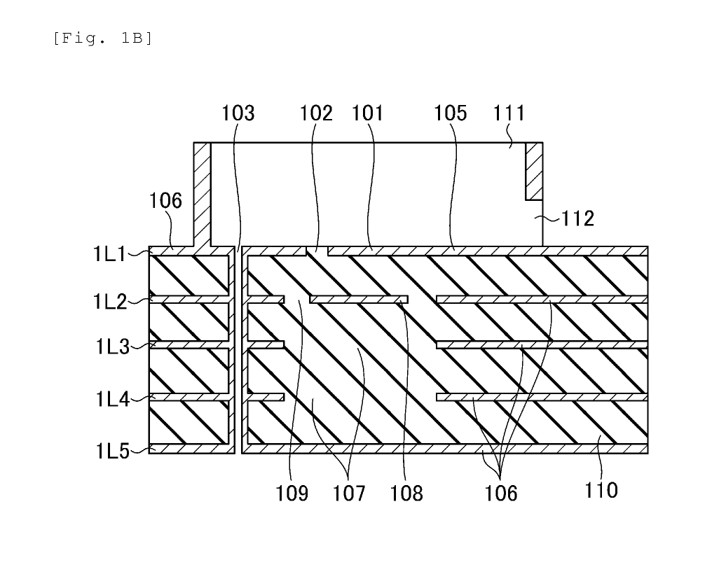

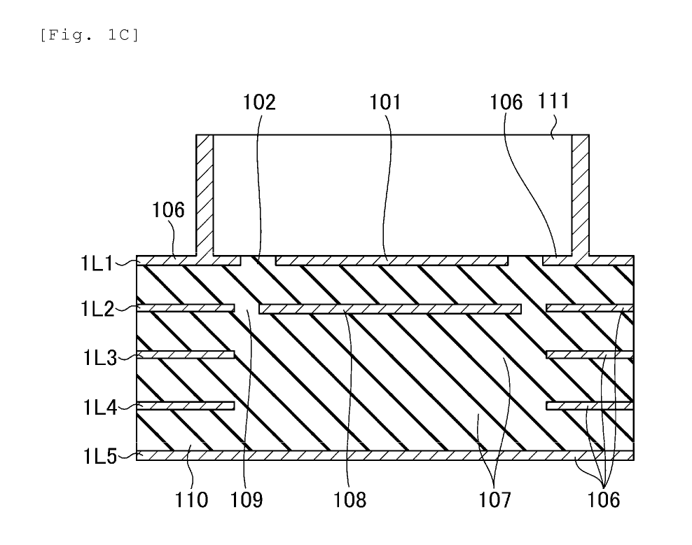

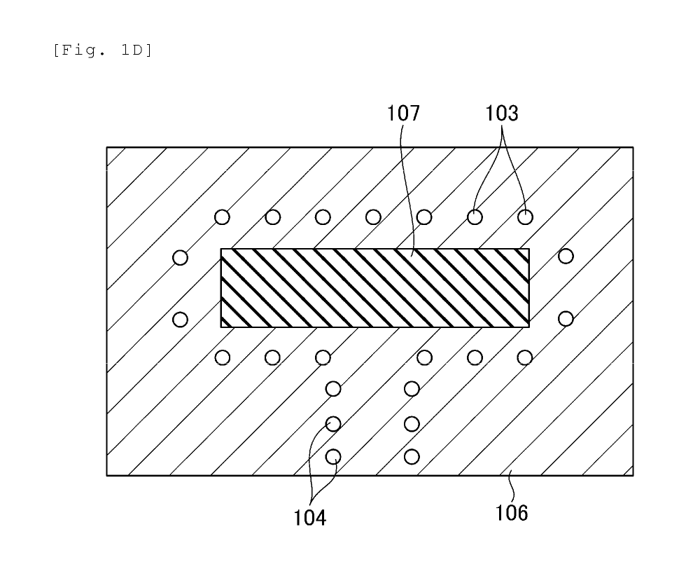

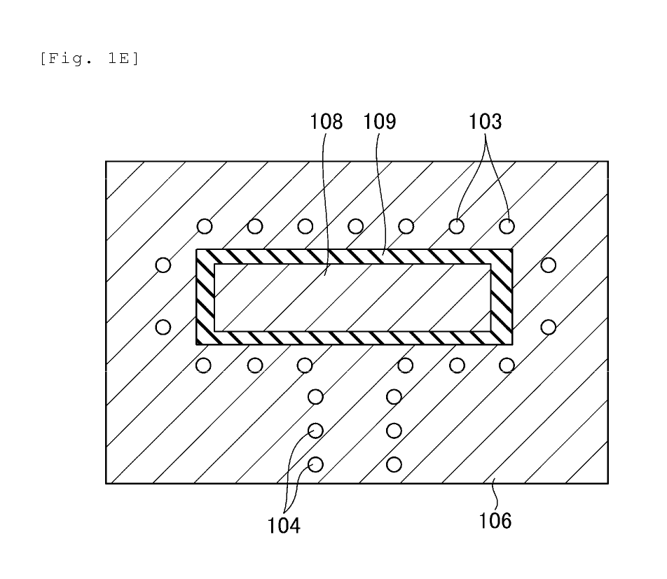

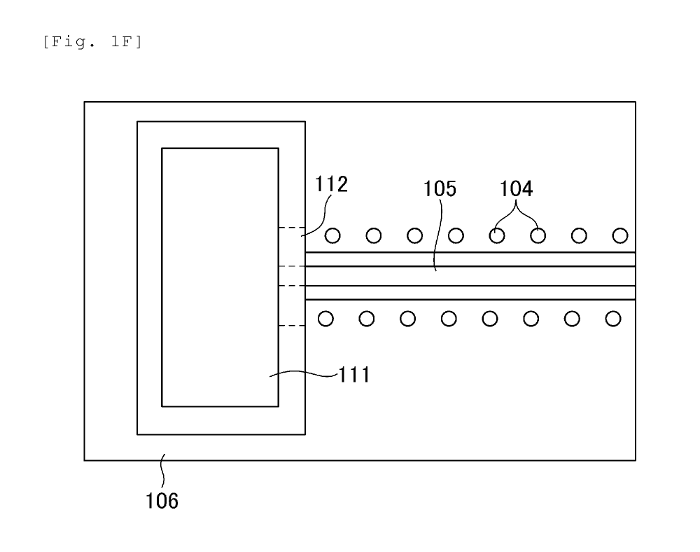

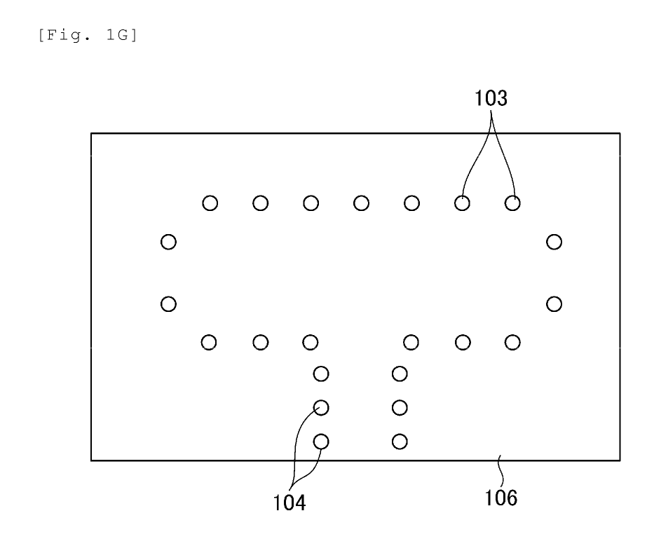

In FIGS. 1A to 1G, an exemplary embodiment of a wideband transition between a planar transmission line segment 105 and a waveguide section 111 is shown.

FIG. 1A is a horizontal cross-section view of a wideband transition between the planar transmission line segment 105 and the waveguide section 111 of the exemplary embodiment of the present invention on the section at a conductor layer 1L1 shown in FIG. 1B. FIG. 1B is a vertical cross-sectional view of the wideband transition of the exemplary embodiment of the present invention shown in FIG. 1A on 1B-1B section. FIG. 1C is a vertical cross-sectional view of the wideband transition of the exemplary embodiment of the present invention shown in FIG. 1A on 1C-1C section. FIG. 1D is a horizontal cross-sectional view of the wideband transition of the exemplary embodiment of the present invention shown in Fig. 1A on the section at conductor layers 1L3 and 1L4. FIG. 1E is a horizontal cross-sectional view of the wideband transition of the exemplary embodiment of the present invention shown in FIG. 1A on the section at conductor layer 1L2. FIG. 1F is a top view of the wideband transition of the exemplary embodiment of the present invention shown in FIG. 1A. FIG. 1G is a bottom view of the wideband transition of the exemplary embodiment of the present invention shown in FIG. 1A.

In this exemplary embodiment, the wideband transition is formed in a substrate including five conductor planes 106, which are respectively arranged in five conductor layers 1L1, 1L2, 1L3, 1L4 and 1L5, stacked from top to bottom and isolated from each other by a substrate filling material 110.

A five-conductor-layer substrate is only an example of multilayer substrates. Number of conductor layers, dielectric characteristics of the filling material and other substrate parameters can be different from the present exemplary embodiment and are to be defined according to an application.

In the exemplary embodiment shown in FIGS. 1A to 1G, the wideband transition further includes a conductor patch 101, an isolating slit 102, a plurality of ground vias 103 of the wideband transition, a plurality of ground vias 104 of the planar transition line section 105, coupling apertures 107, an adjusting plate 108, a separation slit 109 and an opening 112 of the waveguide section 111.

The conductor patch 101 is disposed in the top conductor layer 1L1 and connected to one end of the planar transmission line segment 105. The isolating slit 102 is disposed between the conductor patch 101 and other conductors included in the conductor plane 106 arranged in the top conductor layer 1L1. The plurality of ground vias 103 of the wideband transition are arranged through the multilayer substrate from the top conductor layer 1L1 to the bottom conductor layer 1L5, connected to the conductor planes 106 of each of conductor layers 1L1 to 1L5 and disposed around the conductor patch 101 and the isolating slit 102. The plurality of ground vias 104 of the planar transmission line segment 105 are arranged through the multilayer substrate from the top conductor layer 1L1 to the bottom conductor layer 1L5, connected to the conductor planes 106 of each of conductor layers 1L1 to 1L5 and disposed along both sides of the planar transmission line segment 105. The coupling apertures 107 are disposed in the intermediate conductor layers 1L3 and 1L4 and under the conductor patch 101. The adjusting plate 108 is disposed within a coupling aperture in the intermediate conductor layer 1L2. The separation slit 109 is disposed to isolate the adjusting conductor plate 108 from other conductors at the intermediate conductor layer 1L2. The opening 112 is arranged in one end of the waveguide section 111 to isolate the planar transition line segment 105 from the waveguide section 111.

In this embodiment, another end of the planar transmission line segment 105 serves as a first terminal of the wideband transition. Also, the one end of the waveguide section 111 is disposed above the conductor patch 101 and connected to the conductor plane 106 of the top conductor layer 1L1 (except the opening 112) while the other end of the waveguide section 111 acts as a second terminal of the wideband transition. To improve the electrical performance of the planar transmission line, ground vias 104 are used in the planar transmission line segment 105.

In the transition shown in FIGS. 1A to 1G, widening of the operation bandwidth is provided by an appropriate choice of dimensions of the adjusting conductor plate 108.

### Another Exemplary Embodiment

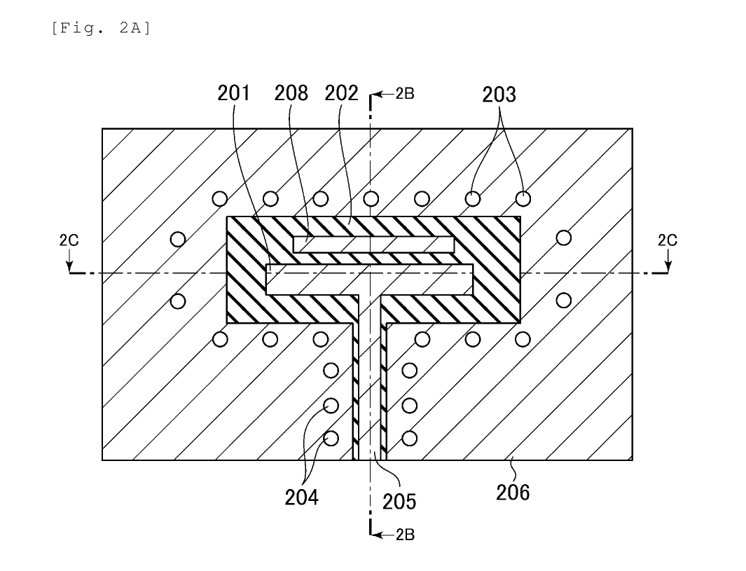

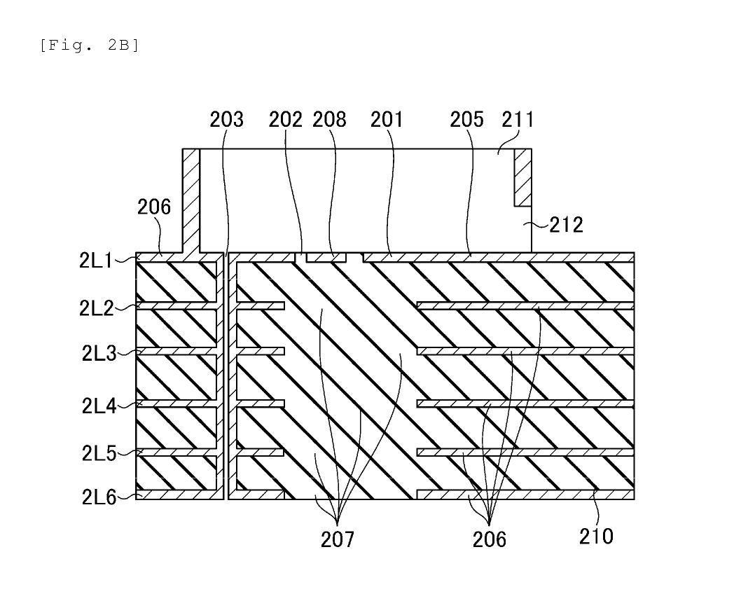

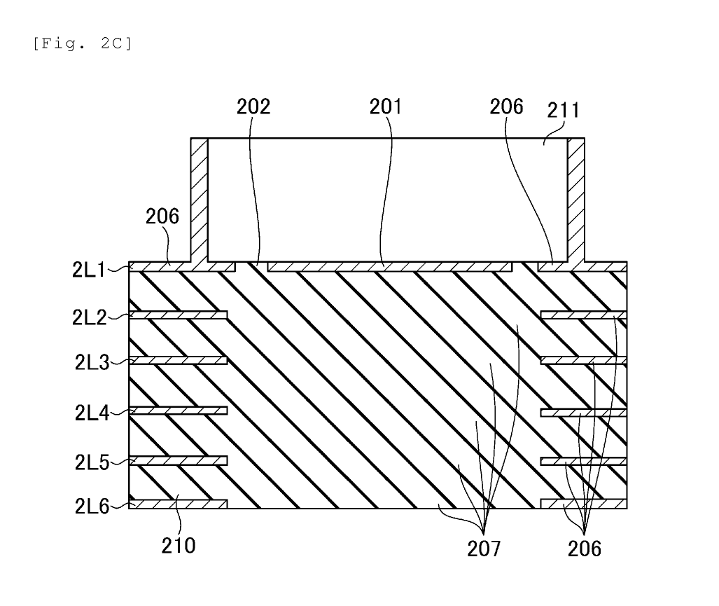

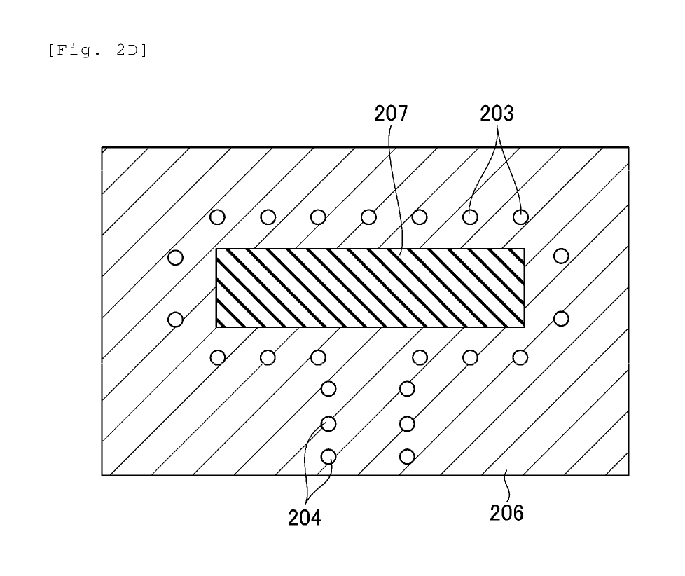

In FIGS. 2A to 2E, another exemplary embodiment of a wideband transition between a planar transmission line segment 205 and a waveguide section 211 is presented.

FIG. 2A is a horizontal cross-section view of a wideband transition between a planar transmission line and a waveguide of another exemplary embodiment of the present invention on the section at conductor layer 2L1 shown in FIG. 2B. FIG. 2B is a vertical cross-sectional view of the wideband transition of another exemplary embodiment of the present invention shown in FIG. 2A on 2B-2B section. FIG. 2C is a vertical cross-sectional view of the wideband transition of another exemplary embodiment of the present invention shown in FIG. 2A on 2C-2C section. FIG. 2D is a horizontal cross-sectional view of the wideband transition of another exemplary embodiment of the present invention shown in FIG. 2A on the section at conductor layers 2L2, 2L3, 2L4, 2L5 and 2L6. FIG. 2E is a top view of the wideband transition of another exemplary embodiment of the present invention shown in FIG. 2A.

In this embodiment, the wideband transition is formed in a substrate including six conductor planes 206, which are respectively arranged in six conductor layers 2L1, 2L2, 2L3, 2L4, 2L5 and 2L6, stacked from top to bottom and isolated from each other by a substrate filling material 210.

In the presented embodiment shown in FIGS. 2A to 2E, the wideband transition further includes a conductor patch 201, an isolating slit 202, a plurality of ground vias 203 of the wideband transition, a plurality of ground vias 204 of the planar transition line segment 205, coupling apertures 207, an adjusting conductor plate 208, and an opening 212 of the waveguide section 211.

The conductor patch 201 is connected to one end of the planar transmission line segment 205. The isolating slit 202 is disposed between the conductor patch 201 and other conductors included in the conductor plane 206 arranged in the top conductor layer 2L1. The plurality of ground vias 203 of the wideband transition are arranged through the multilayer substrate from the top conductor layer 2L1 to the bottom conductor layer 2L6, connected to the conductor planes 206 of each of conductor layers 2L1 to 2L6 and disposed around the conductor patch 201, the adjusting conductor plate 208 and the isolating slit 202. The plurality of ground vias 204 of the planar transmission line segment 205 are arranged through the multilayer substrate from the top conductor layer 2L1 to the bottom conductor layer 2L6, connected to the conductor planes 206 of each of conductor layers 2L1 to 2L6 and disposed along both sides of the planar transmission line segment 205. The coupling apertures 207 are disposed in the intermediate conductor layers 2L2, 2L3, 2L4 and 2L5 and the bottom conductor layer 2L6 and under the conductor patch 201. The adjusting conductor plate 208 is disposed in conductor layer 2L1 and isolated from other conductors in the conductor plane 206 by the isolating slit 202. The opening 212 is arranged in one end of the waveguide section 211 to isolate the planar transition line segment 205 from the waveguide section 211.

In this embodiment, another end of the planar transmission line segment 205 serves as a first terminal of the wideband transition. Also, the one end of the waveguide section 211 is disposed above the conductor patch 201 and connected to the conductor plane 206 of the top conductor layer 2L1 (except the opening 212) while another end of the waveguide section 211 acts as a second terminal of the wideband transition. To improve the electrical performance of the planar transmission line, ground vias 204 are used in the planar transmission line segment 205.

In the transition shown in FIGS. 2A to 2E, widening of the operation bandwidth is provided by an appropriate choice of dimensions of the adjusting conductor plate 208.

### Further Another Exemplary Embodiment

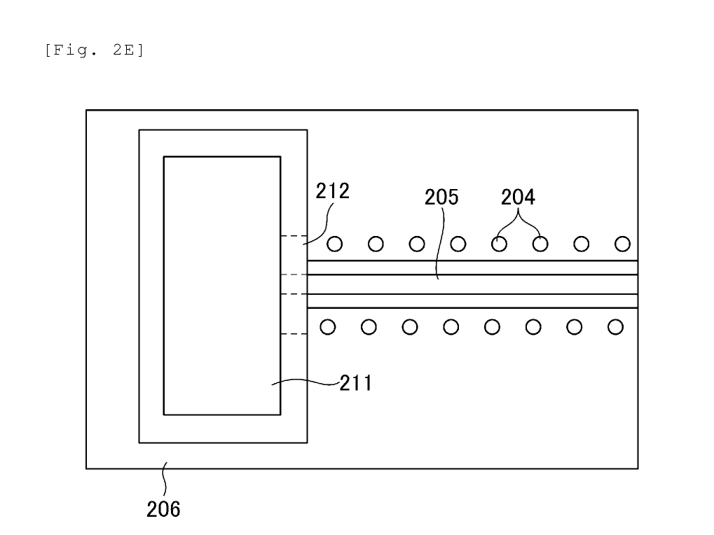

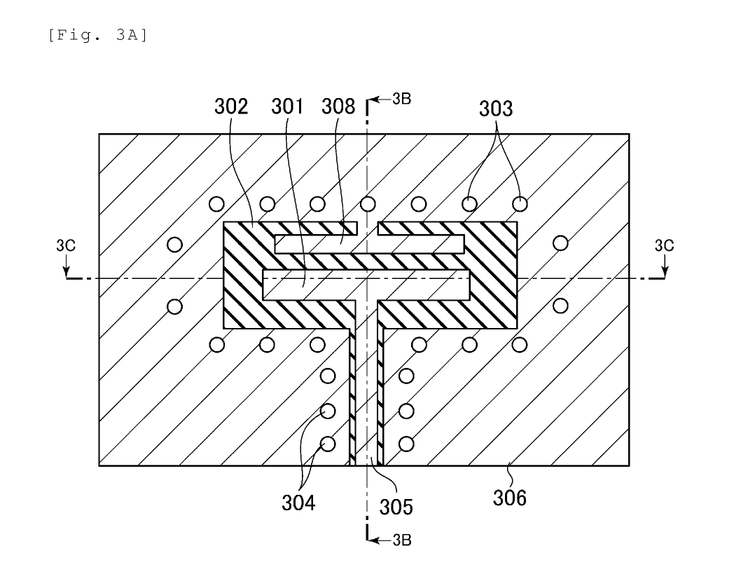

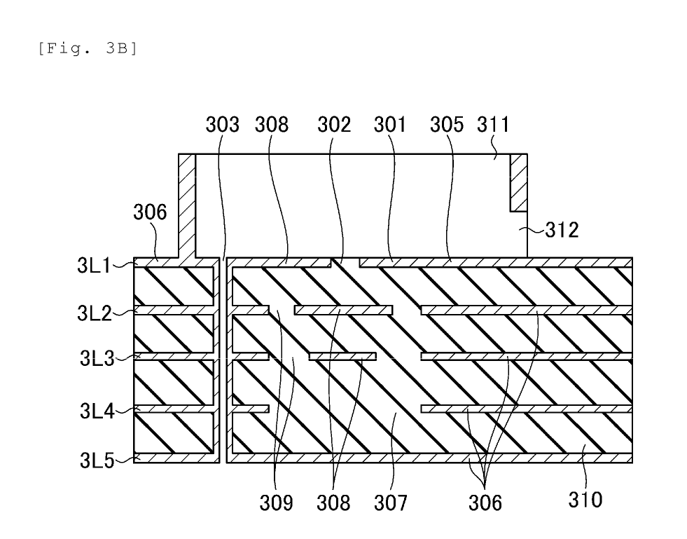

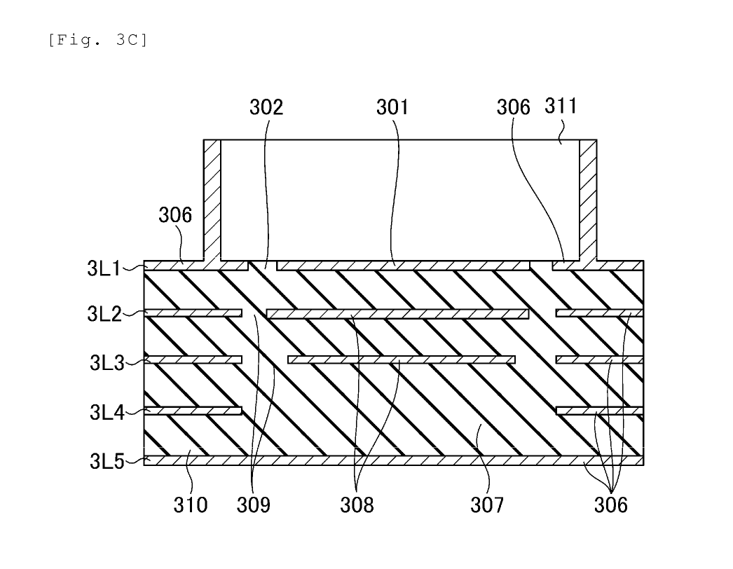

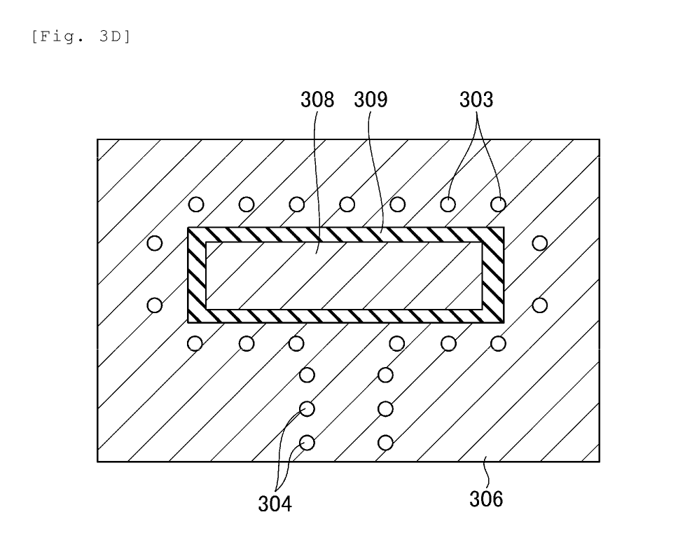

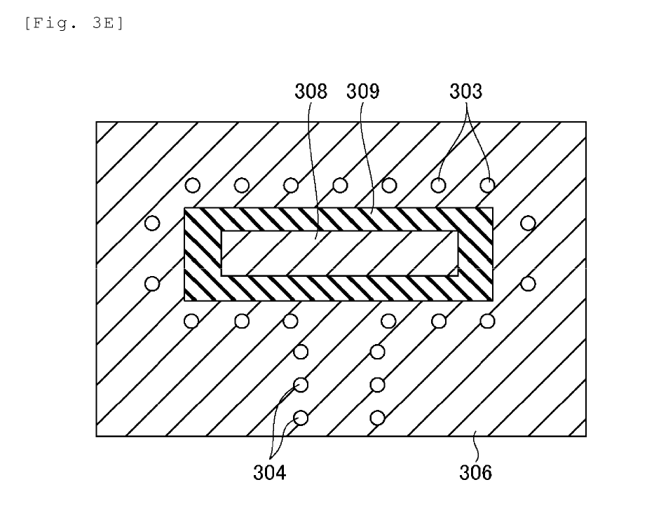

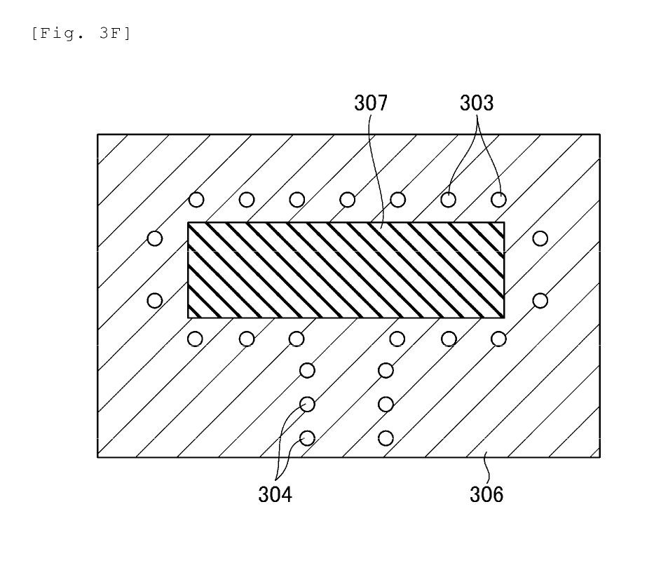

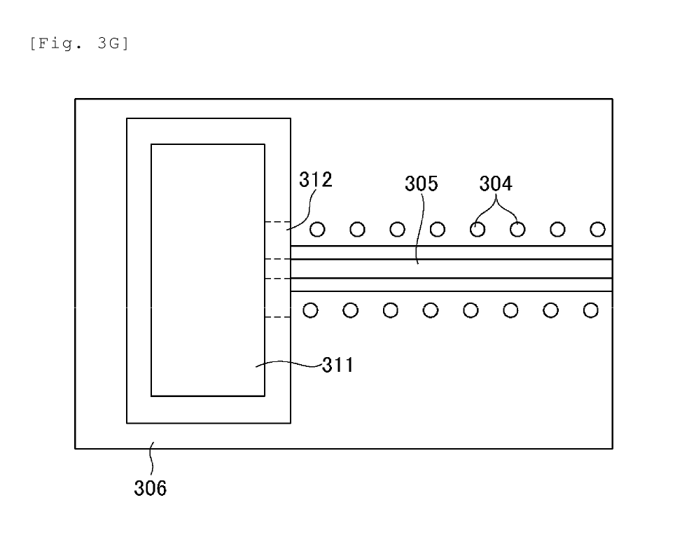

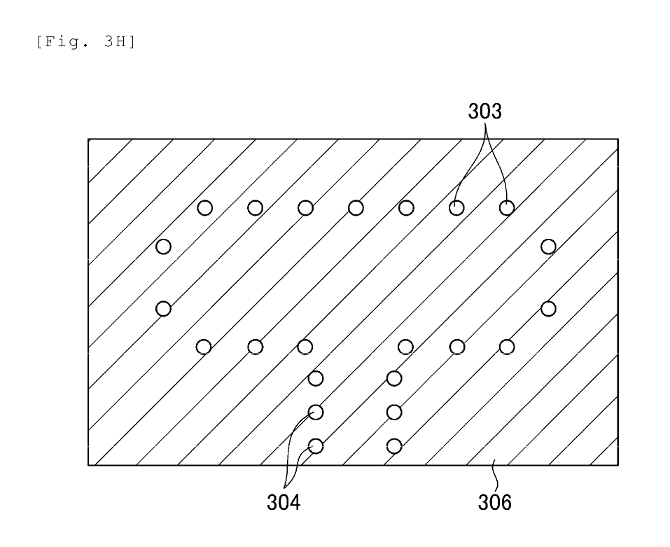

In FIGS. 3A to 3H, further another exemplary embodiment of a wideband transition between a planar transmission line segment 305 and a waveguide section 311 is presented.

FIG. 3A is a horizontal cross-section view of a wideband transition between a planar transmission line and a waveguide of further another exemplary embodiment of the present invention on the section at conductor layer 3L1 shown in FIG. 3B. FIG. 3B is a vertical cross-sectional view of the wideband transition of further another exemplary embodiment of the present invention shown in FIG. 3A on 3B-3B section. FIG. 3C is a vertical cross-sectional view of the wideband transition of further another exemplary embodiment of the present invention shown in FIG. 3A on 3C-3C section. FIG. 3D is a horizontal cross-sectional view of the wideband transition of further another exemplary embodiment of the present invention shown in FIG. 3A on the section at conductor layer 3L2. FIG. 3E is a horizontal cross-sectional view of the wideband transition of further another exemplary embodiment of the present invention shown in FIG. 3A on the section at conductor layer 3L3. FIG. 3F is a horizontal cross-sectional view of the wideband transition of further another exemplary embodiment of the present invention shown in FIG. 3A on the section at conductor layer 3L4. FIG. 3G is a top view of the wideband transition of further another exemplary embodiment of the present invention shown in FIG. 3A. FIG. 3H is a bottom view of the wideband transition of further another exemplary embodiment of the present invention shown in FIG. 3A.

In this exemplary embodiment, the wideband transition is formed in a substrate including five conductor planes 306, which are respectively formed in five conductor layers 3L1, 3L2, 3L3, 3L4 and 3L5, stacked from top to bottom and isolated by a substrate filling material 310.

In the presented embodiment shown in FIGS. 3A to 3H, the wideband transition further includes a conductor patch 301, an isolating slit 302, a plurality of ground vias 303 of the wideband transition, a plurality of ground vias 304 of the planar transition line segment 305, a coupling aperture 307, three adjusting conductor plates 308, separation slits 309 and an opening 312 of the waveguide section 311.

The conductor patch 301 is disposed in the top conductor layer 3L1 and connected to one end of the planar transmission line segment 305. The isolating slit 302 is disposed between the conductor patch 301 and other conductors included in the conductor plane 306 arranged in the top conductor layer 3L1. The plurality of ground vias 303 of the wideband transition are arranged through the multilayer substrate from the top conductor layer 3L1 to the bottom conductor layer 3L5, connected to the conductor planes 306 of each of conductor layers 3L1 to 3L5 and disposed around the conductor patch 301, the first adjusting conductor plate 308 and the isolating slit 302. The plurality of ground vias 304 of the planar transmission line section 305 are arranged through the multilayer substrate from the top conductor layer 3L1 to the bottom conductor layer 3L5, connected to the conductor planes 306 of each of conductor layers 3L1 to 3L5 and disposed along both sides of the planar transmission line segment 305. The coupling aperture 307 is disposed in the intermediate conductor layer 3L4 and under the conductor patch 301. The first adjusting conductor plate 308 is disposed in the top conductor layer 3L1, connected to the conductor plane 306 at the top conductor layer 3L1 and isolated from the conductor patch 301 by the isolating slit 302. The second and third adjusting conductor plates 308 are disposed in intermediate conductor layers 3L2 and 3L3, respectively. The separation slits 309 are disposed to isolate the second and third adjusting conductor plates 308 from other conductors at the intermediate conductor layers 3L2 and 3L3 . The opening 312 is arranged in one end of the waveguide section 311 to isolate the planar transition line segment 305 from the waveguide section 311.

In this embodiment, another end of the planar transmission line segment 305 serves as a first terminal of the wideband transition. Also, the one end of the waveguide section 311 is disposed above the conductor patch 301 and connected to the conductor plane 306 at the top conductor layer 3L1 (except the opening 312) while another end of the waveguide segment 311 acts as a second terminal of the wideband transition. To improve the electrical performance of the planar transmission line, ground vias 304 are used in the planar transmission line segment 305.

In the transition shown in FIGS. 3A to 3H, widening of the operation bandwidth is provided by an appropriate choice of dimensions of the adjusting conductor plates 308.

### Further Another Exemplary Embodiment

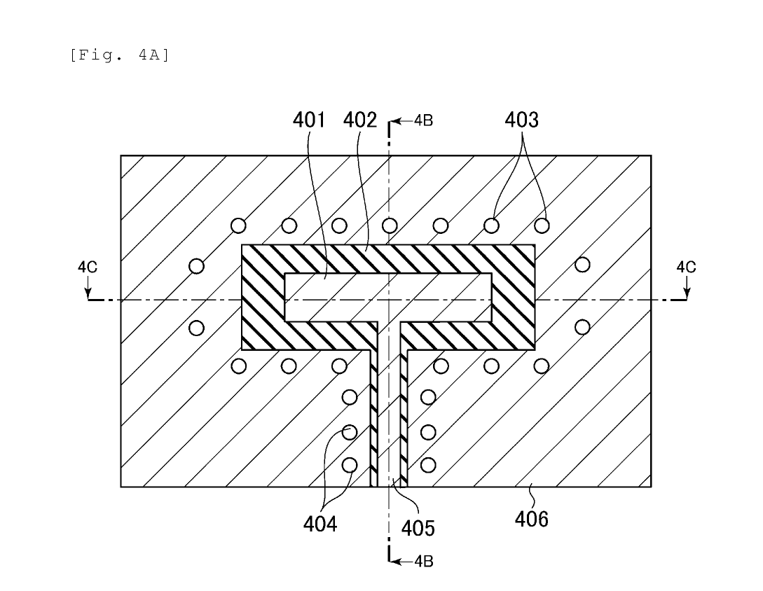

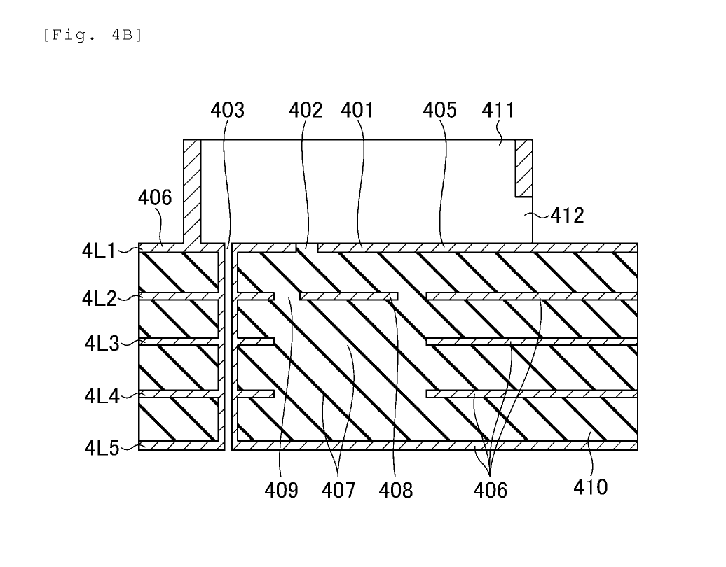

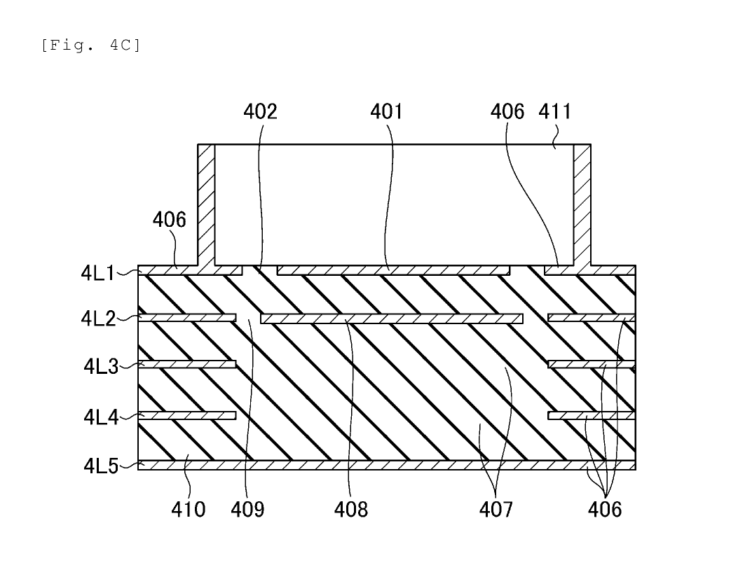

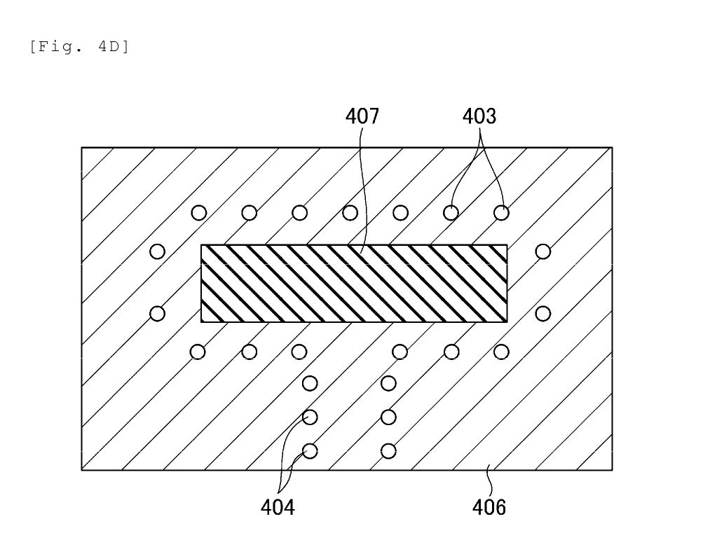

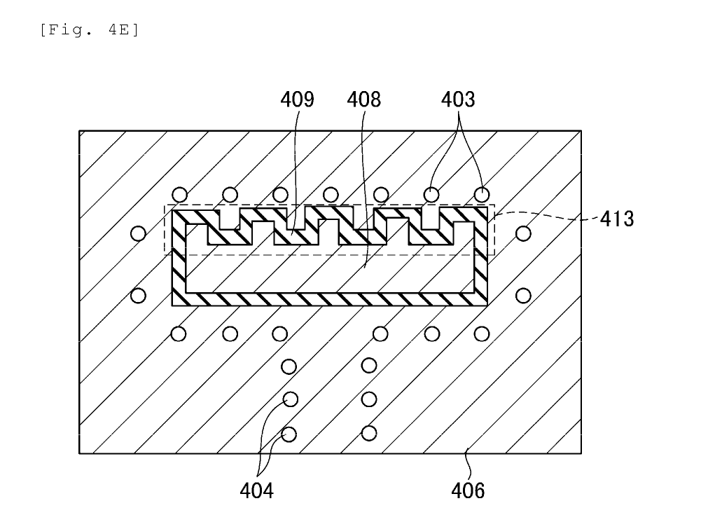

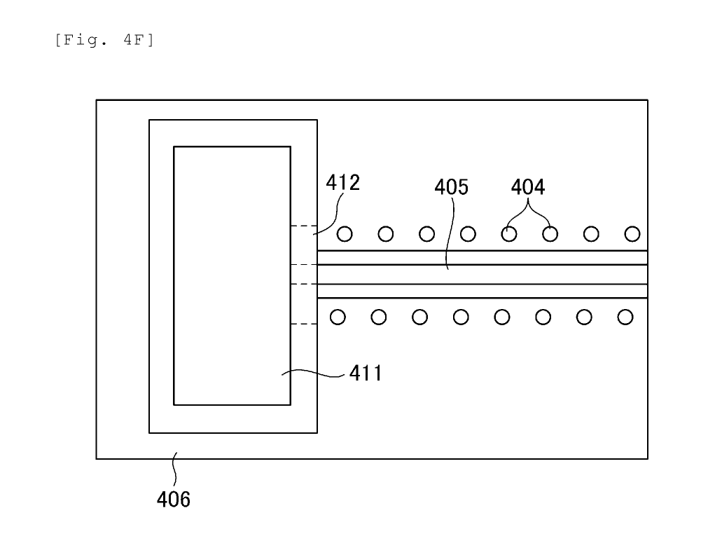

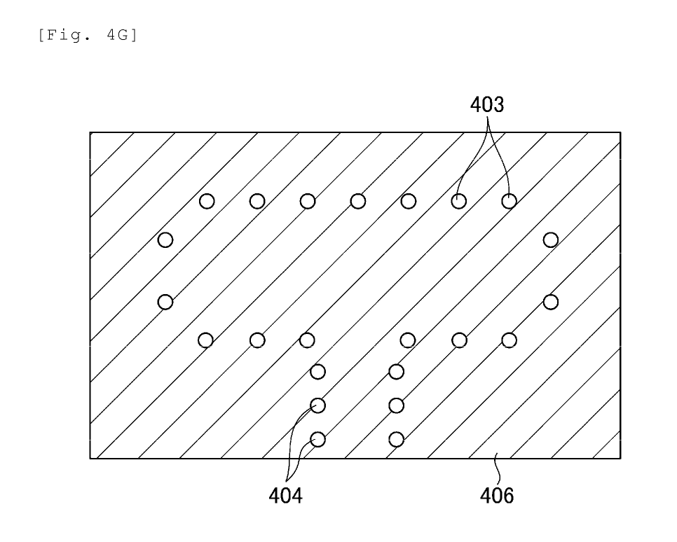

In FIGS. 4A to 4G, further another exemplary embodiment of a wideband transition between a planar transmission line segment 405 and a waveguide section 411 is presented.

FIG. 4A is a horizontal cross-section view of a wideband transition between a planar transmission line and a waveguide of further another exemplary embodiment of the present invention on the section at conductor layer 4L1 shown in FIG. 4B. FIG. 4B is a vertical cross-sectional view of the wideband transition of further another exemplary embodiment of the present invention shown in FIG. 4A on 4B-4B section. FIG. 4C is a vertical cross-sectional view of the wideband transition of further another exemplary embodiment of the present invention shown in FIG. 4A on 4C-4C section. FIG. 4D is a horizontal cross-sectional view of the wideband transition of further another exemplary embodiment of the present invention shown in FIG. 4A on the section at conductor layers 4L3 and 4L4. FIG. 4E is a horizontal cross-sectional view of the wideband transition of further another exemplary embodiment of the present invention shown in FIG. 4A on the section at conductor layer 4L2. FIG. 4F is atop view of the wideband transition of further another exemplary embodiment of the present invention shown in FIG. 4A. FIG. 4G is a bottom view of the wideband transition of further another exemplary embodiment of the present invention shown in FIG. 4A.

In this exemplary embodiment, the wideband transition is formed in a substrate including five conductor planes 406, which are respectively arranged in five conductor layers 4L1, 4L2, 4L3, 4L4 and 4L5, stacked from top to bottom and isolated from each other by a substrate filling material 410.

In the presented exemplary embodiment shown in FIGS. 4A to 4G, the wideband transition includes a conductor patch 401, an isolating slit 402, a plurality of ground vias 403 of the wideband transition, a plurality of ground vias 404 of the planar transition line section 405, coupling apertures 407, an adjusting conductor plate 408, a separation slit 409, and an opening 412.

The conductor patch 401 is connected to one end of the planar transmission line segment 405. The isolating slit 402 is disposed between the conductor patch 401 and other conductors of the conductor plane 406 arranged in the top conductor layer 4L1. The plurality of ground vias 403 of the wideband transition are arranged through the multilayer substrate from the top conductor layer 4L1 to the bottom conductor layer 4L5, connected to the conductor planes 406 of each of conductor layers 4L1 to 4L5 and disposed around the conductor patch 401 and the isolating slit 402. The plurality of ground vias 404 of the planar transmission line segment 405 are arranged through the multilayer substrate from the top conductor layer 4L1 to the bottom conductor layer 4L5, connected to the conductor planes 406 of each of conductor layers 4L1 to 4L5 and disposed along both sides of the planar transmission line segment 405. The coupling apertures 407 are disposed in the intermediate conductor layers 4L3 and 4L4 and under the conductor patch 401. The adjusting conductor plate 408 is disposed in the intermediate conductor layer 4L2. The separation slit 409 is disposed to isolate the adjusting conductor plate 408 from other conductors at the conductor layer 4L2. The opening 412 is arranged in one end of the waveguide section 411 to isolate the planar transition line segment 405 from the waveguide section 411.

In this embodiment, the adjusting conductor plate 408 and the conductor plane 406 in the intermediate conductor layer 4L2 has a coupling section 413. In the coupling section 413, each of the adjusting conductor plate 408 and the conductor plane 406 has an edge with a corrugated shape and those edges with the corrugated shape are facing each other. The coupling section 413 is used to additionally control an operation bandwidth of the transition, especially to enhance coupling between the adjusting conductor plate 408 and other conductors in the intermediate conductor layer 4L2.

In the exemplary embodiment, another end of the planar transmission line segment 405 serves as a first terminal of the wideband transition. Also, the one end of the waveguide section 411 is disposed above the conductor patch 401 and connected to the conductor plane 406 of the top conductor layer 4L1 (except the opening 412) while the other end of the waveguide section 411 acts as a second terminal of the wideband transition. To improve the electrical performance of the planar transmission line, ground vias 404 are used in the planar transmission line segment 405.

In the transition shown in FIGS. 4A to 4G, widening of the operation bandwidth is provided by an appropriate choice of dimensions and shapes of the adjusting conductor plate 408 and its coupling section 413.

### Further Another Exemplary Embodiment

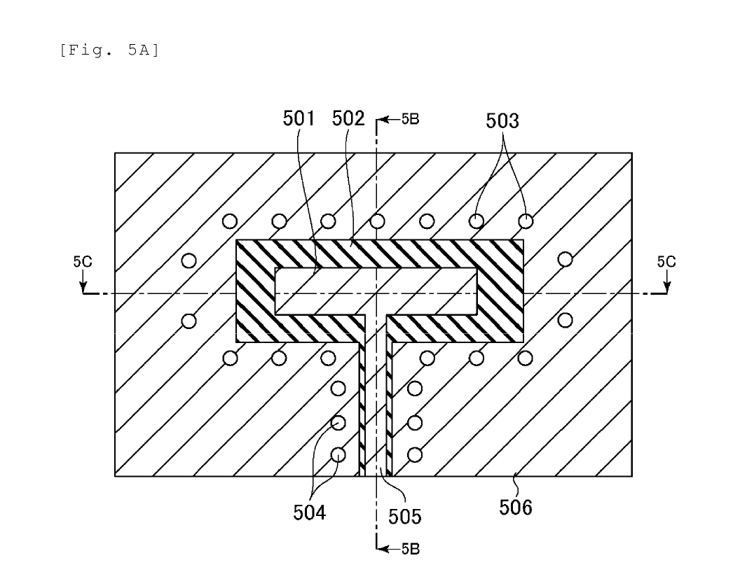

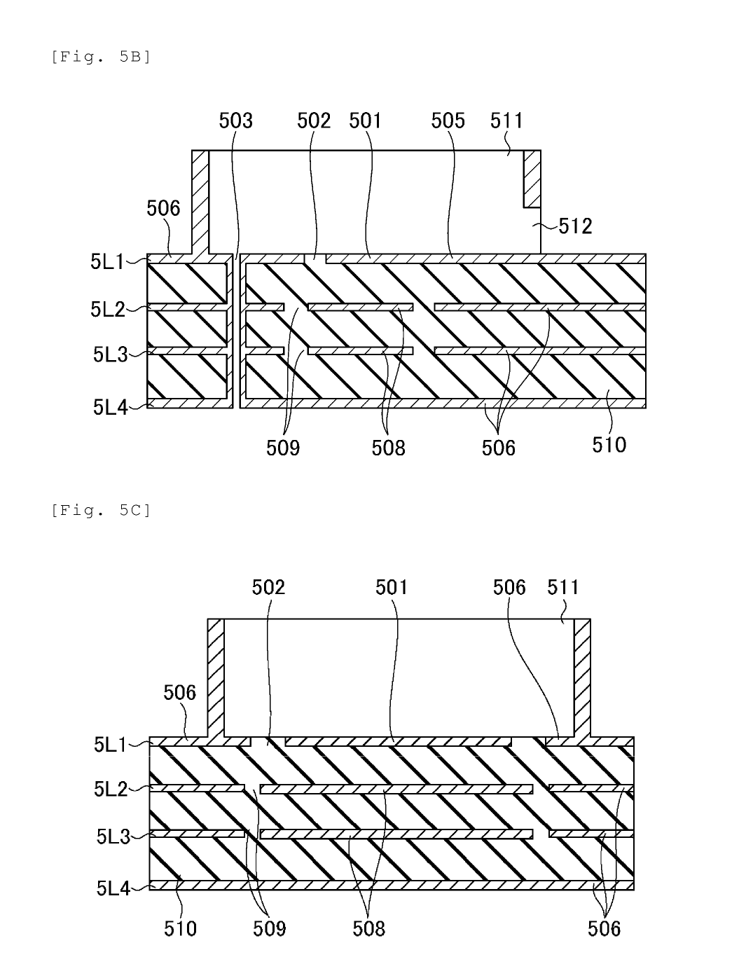

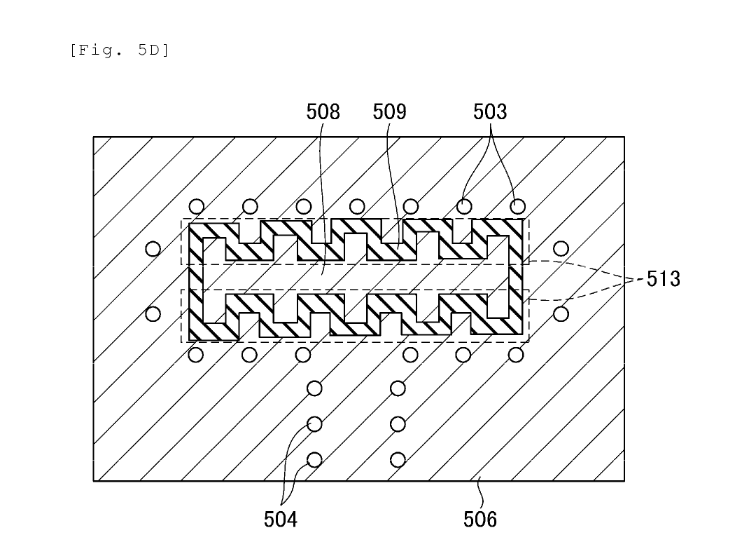

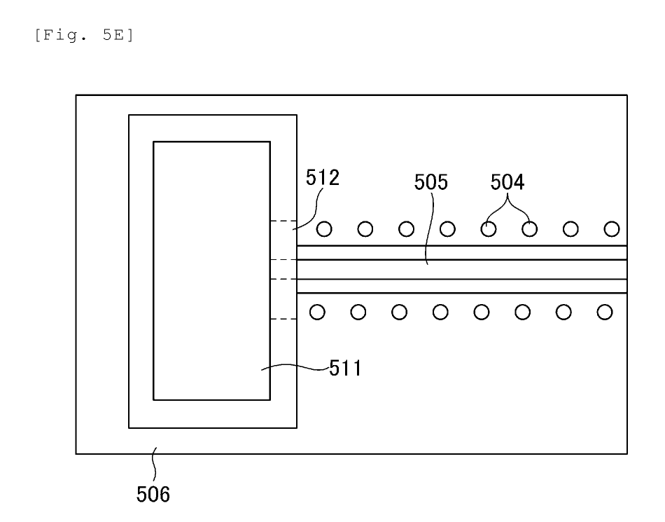

In FIGS. 5A to 5F, further another exemplary embodiment of a wideband transition between a planar transmission line segment 505 and a waveguide section 511 is presented.

FIG. 5A is a horizontal cross-section view of a wideband transition between a planar transmission line and a waveguide of further another exemplary embodiment of the present invention on the section at conductor layer 5L1 shown in FIG. 5B. FIG. 5B is a vertical cross-sectional view of the wideband transition of further another exemplary embodiment of the present invention shown in FIG. 5A on 5B-5B section. FIG. 5C is a vertical cross-sectional view of the wideband transition of further another exemplary embodiment of the present invention shown in FIG. 5A on 5C-5C section. FIG. 5D is a horizontal cross-sectional view of the wideband transition of further another exemplary embodiment of the present invention shown in FIG. 5A on the section at conductor layers 5L2 and 5L3. FIG. 5E is a top view of the wideband transition of further another exemplary embodiment of the present invention shown in FIG. 5A. FIG. 5F is a bottom view of the wideband transition of further another exemplary embodiment of the present invention shown in FIG. 5A.

In this exemplary embodiment, the wideband transition is formed in a substrate including four conductor planes 506, which are respectively arranged in four conductor layers 5L1, 5L2, 5L3 and 5L4, stacked from top to bottom and isolated by a substrate filling material 510.

In the presented embodiment shown in FIGS. 5A to 5F, the wideband transition further includes a conductor patch 501, an isolating slit 502, a plurality of ground vias 503 of the wideband transition, a plurality of ground vias 504 of the planar transition line section 505, two adjusting conductor plates 508, separation slits 509, and an opening 512 of the waveguide section 511.

The conductor patch 501 is disposed in the top conductor layer 5L1 and connected to one end of the planar transmission line segment 505. The isolating slit 502 is disposed between the conductor patch 501 and other conductors of the conductor plane 506 arranged in the top conductor layer 5L1. Two adjusting conductor plates 508 are respectively disposed in two intermediate conductor layers 5L2 and 5L3. The separation slits 509 are disposed to isolate two adjusting conductor plates 508 from other conductors at the intermediate conductor layer 5L2 and 5L3. The opening 512 is arranged in one end of the waveguide section 511 to isolate the planar transition line segment 505 from the waveguide section 511.

In this embodiment, each of two adjusting conductor plates 508 has two coupling sections 513. In each coupling section 513, each of the adjusting conductor plate 508 and the conductor plane 506 has an edge with a corrugated shape and those edges with the corrugated shape are facing each other. The coupling sections 513 are used to additionally control an operation bandwidth of the transition, especially to enhance coupling between the adjusting conductor plates 508 and other conductors in the intermediate conductor layers 5L2 and 5L3.

In the embodiment, another end of the planar transmission line segment 505 serves as a first terminal of the wideband transition. Also, the one end of the waveguide section 511 is disposed above the conductor patch 501 and connected to the conductor plane 506 of the top conductor layer 5L1 (except the opening 512) while another end of the waveguide section 511 acts as a second terminal of the wideband transition. To improve the electrical performance of the planar transmission line, ground vias 504 are used in the planar transmission line segment 505.

In the transition shown in FIGS. 5A to 5F, widening of the operation bandwidth is provided by an appropriate choice of dimensions and shapes of the adjusting conductor plates 508 and their coupling sections 513.

### Further Another Exemplary Embodiment

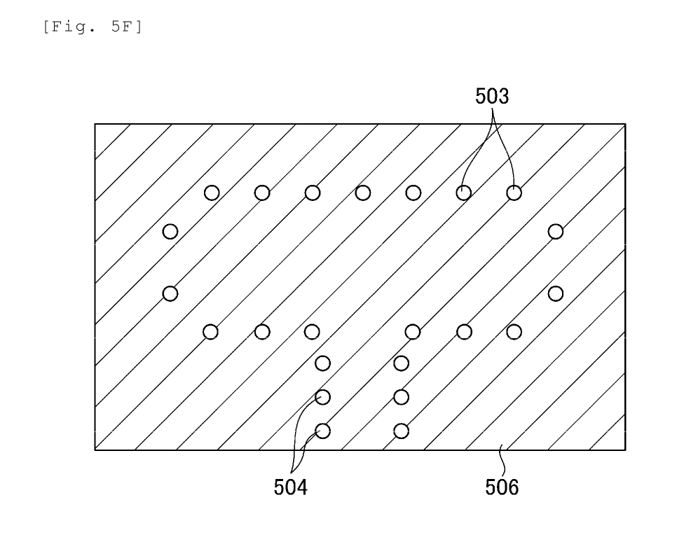

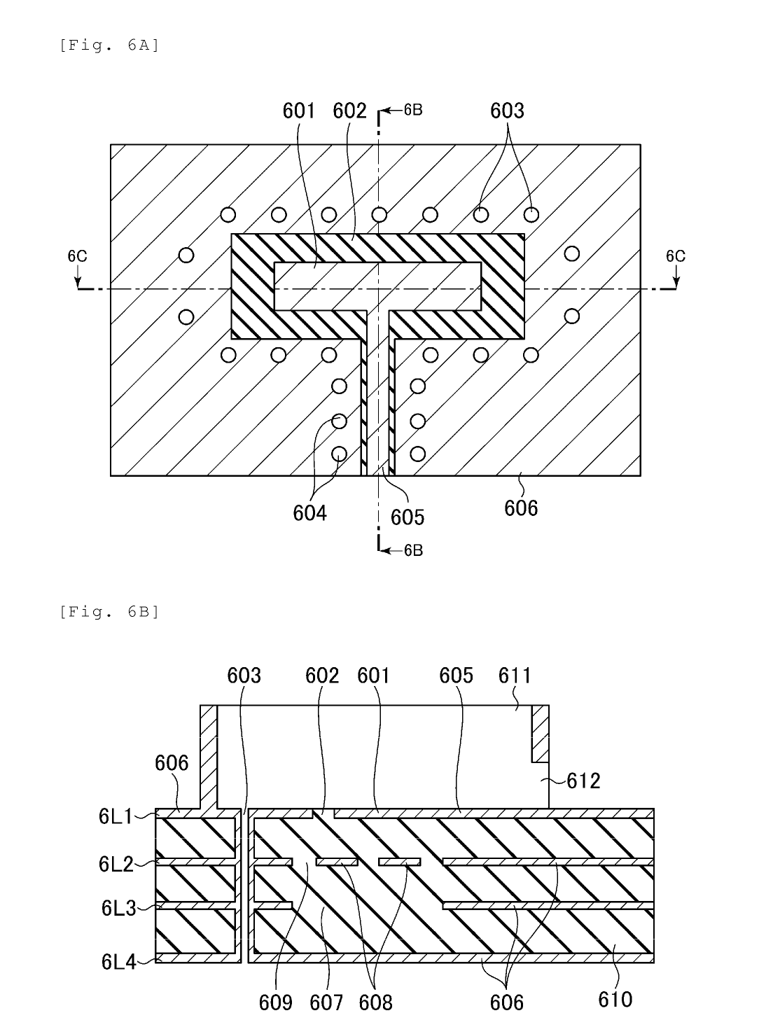

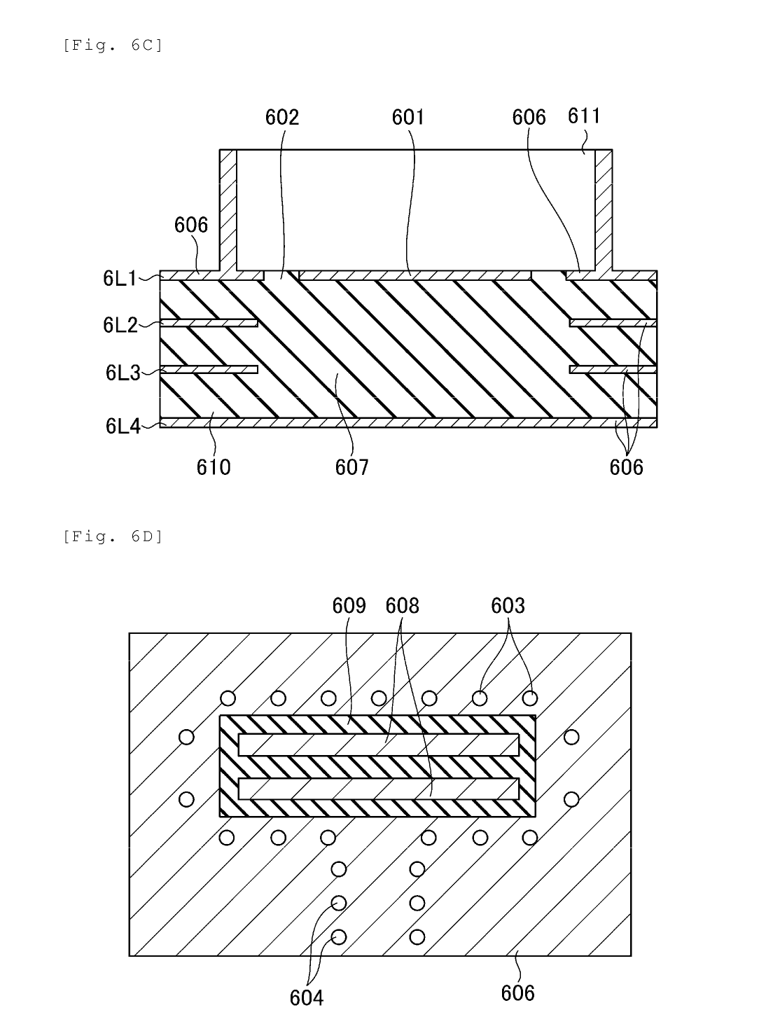

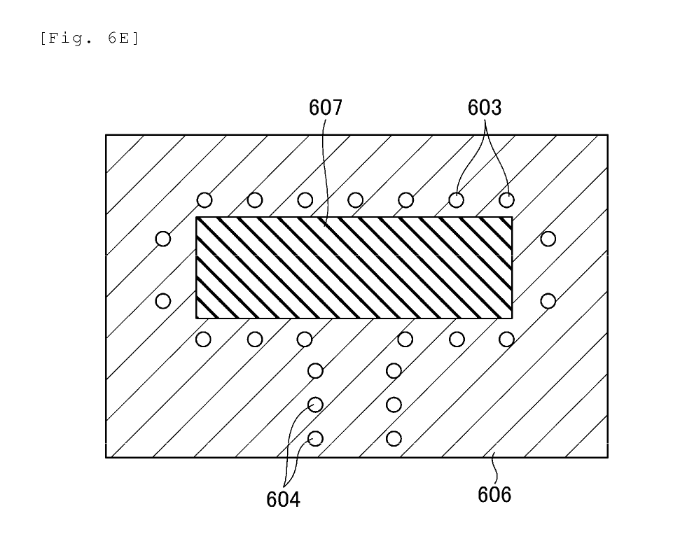

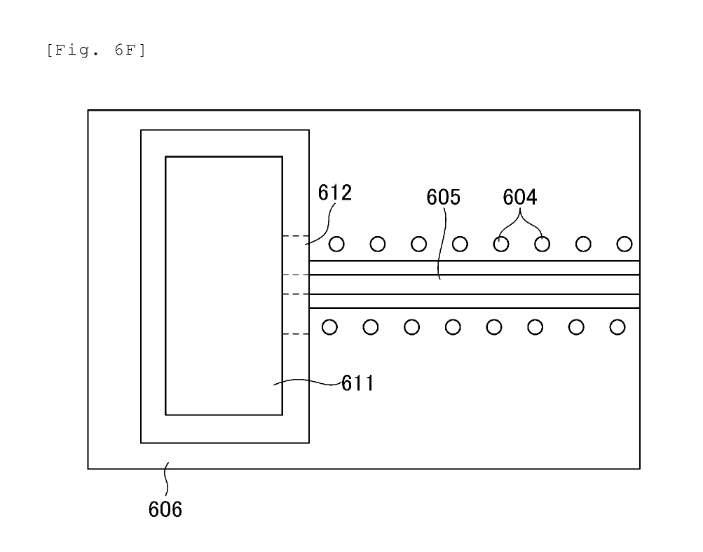

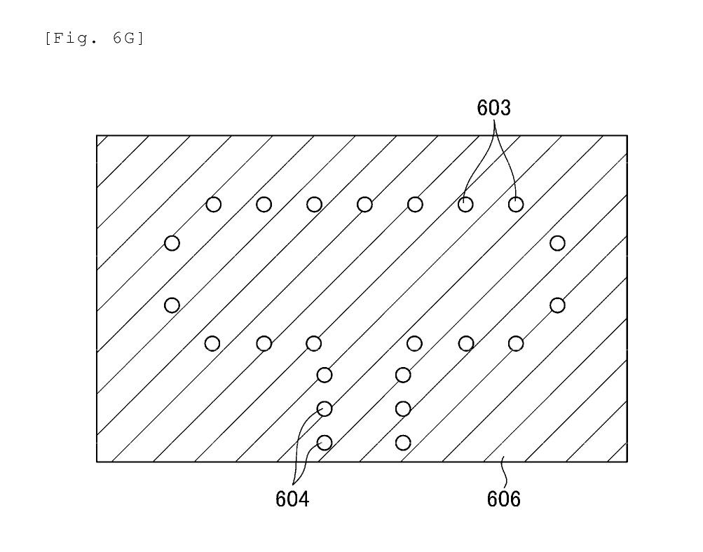

In FIGS. 6A to 6G, further another exemplary embodiment of a wideband transition between a planar transmission line segment 605 and a waveguide section 611 is presented.

FIG. 6A is a horizontal cross-section view of a wideband transition between a planar transmission line and a waveguide of further another exemplary embodiment of the present invention on the section at conductor layer 6L1 shown in FIG. 6B. FIG. 6B is a vertical cross-sectional view of the wideband transition of further another exemplary embodiment of the present invention shown in FIG. 6A on 6B-6B section. FIG. 6C is a vertical cross-sectional view of the wideband transition of further another exemplary embodiment of the present invention shown in FIG. 6A on 6C-6C section. FIG. 6D is a horizontal cross-sectional view of the wideband transition of further another exemplary embodiment of the present invention shown in FIG. 6A on the section at conductor layer 6L2. FIG. 6E is a horizontal cross-sectional view of the wideband transition of further another exemplary embodiment of the present invention shown in FIG. 6A on the section at conductor layer 6L3. FIG. 6F is a top view of the wideband transition of further another exemplary embodiment of the present invention shown in FIG. 6A. FIG. 6G is a bottom view of the wideband transition of further another exemplary embodiment of the present invention shown in FIG. 6A.

In this exemplary embodiment, the wideband transition is formed in a substrate including four conductor planes 606, which are respectively arranged in four conductor layers 6L1, 6L2, 6L3 and 6L4, stacked from top to bottom and isolated from each other by a substrate filling material 610.

In the presented exemplary embodiment shown in FIGS.

6A to 6G, the wideband transition further includes a conductor patch 601, an isolating slit 602, a plurality of ground vias 603 of the wideband transition, a plurality of ground vias 604 of the planar transition line segment 605, a coupling aperture 607, two adjusting conductor plates 608, separation slits 609 and an opening 612 in the waveguide section 611.

The conductor patch 601 is disposed in the top conductor layer 1L1 and connected to one end of the planar transmission line segment 605. The isolating slit 602 is disposed between the conductor patch 601 and other conductors included in the conductor plane 606 arranged in the top conductor layer 6L1. The plurality of ground vias 603 of the wideband transition are arranged through the multilayer substrate from the top conductor layer 6L1 to the bottom conductor layer 6L4, connected to the conductor planes 606 of each of conductor layers 6L1 to 6L4 and disposed around the conductor patch 601 and the isolating slit 602. The plurality of ground vias 604 of the planar transmission line segment 605 are arranged through the multilayer substrate from the top conductor layer 6L1 to the bottom conductor layer 6L4, connected to the conductor planes 606 of each of conductor layers 6L1 to 6L4 and disposed along both sides of the planar transmission line segment 605. The coupling aperture 607 is disposed in the intermediate conductor layer 6L3 and under the conductor patch 601. Both of two adjusting conductor plates 608 are disposed in conductor layer 6L2. The separation slits 609 are disposed to isolate two adjusting conductor plates 608 from each other and other conductors at the intermediate conductor layer 6L2. The opening 612 is arranged in one end of the waveguide section 611 to isolate the planar transition line segment 605 from the waveguide section 611.

In this exemplary embodiment, two adjusting conductor plates 608 disposed at the same intermediate conductor layer 6L2 are used to control an operation bandwidth of the transition.

In this exemplary embodiment, another end of the planar transmission line segment 605 serves as a first terminal of the wideband transition. Also, the one end of the waveguide section 611 is disposed above the conductor patch 601 and connected to the conductor plane 606 of the top conductor layer 6L1 (except the opening 612) while another end of the waveguide section 611 acts as a second terminal of the wideband transition. To improve the electrical performance of the planar transmission line, ground vias 604 are used in the planar transmission line segment 605.

In the transition shown in FIGS. 6A to 6G, widening of the operation bandwidth is provided by an appropriate choice of dimensions of the adjusting conductor plates 608.

### Further Another Exemplary Embodiment

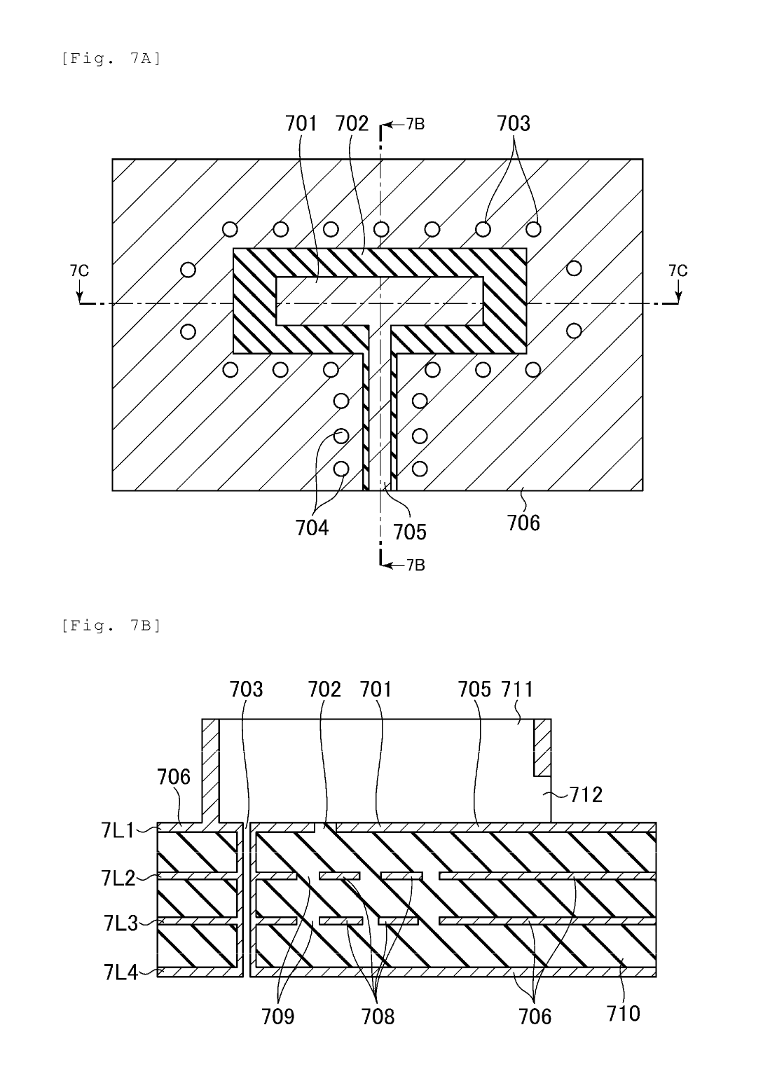

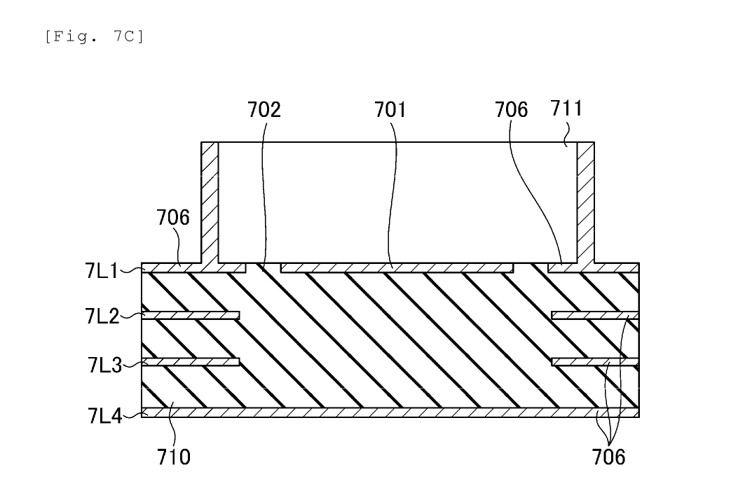

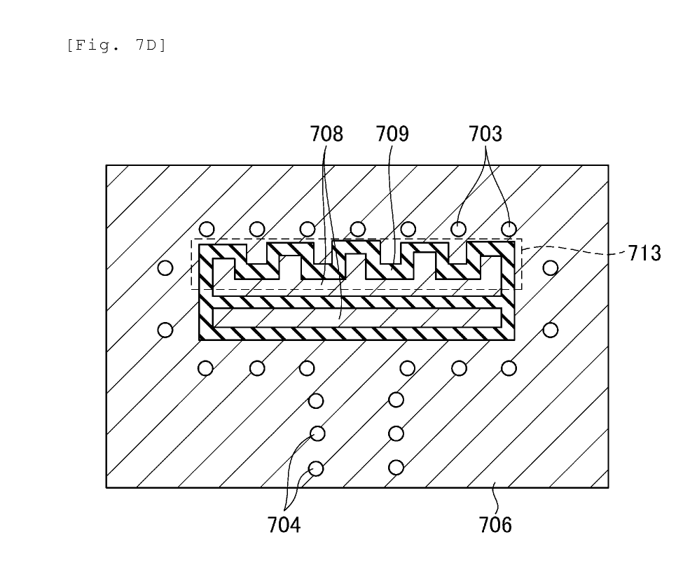

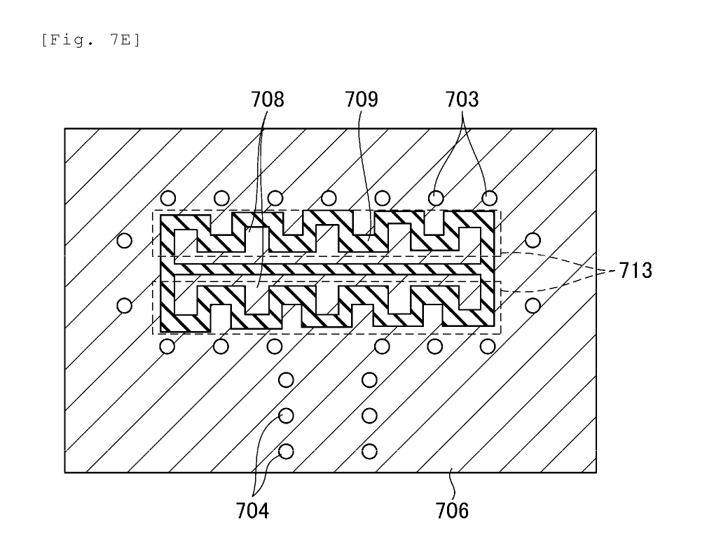

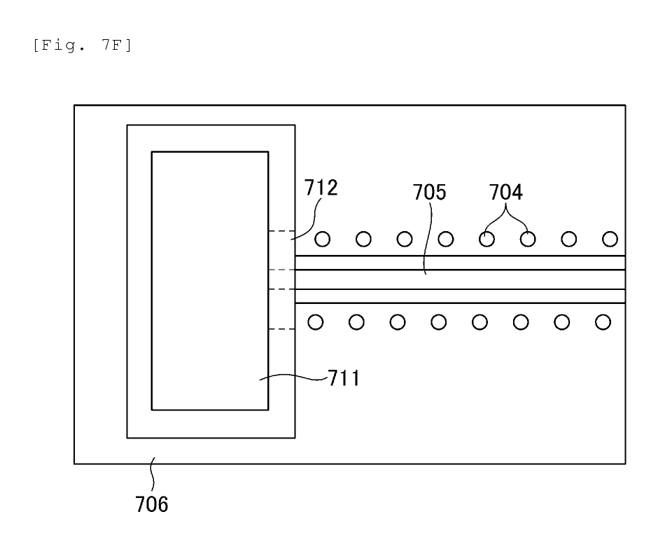

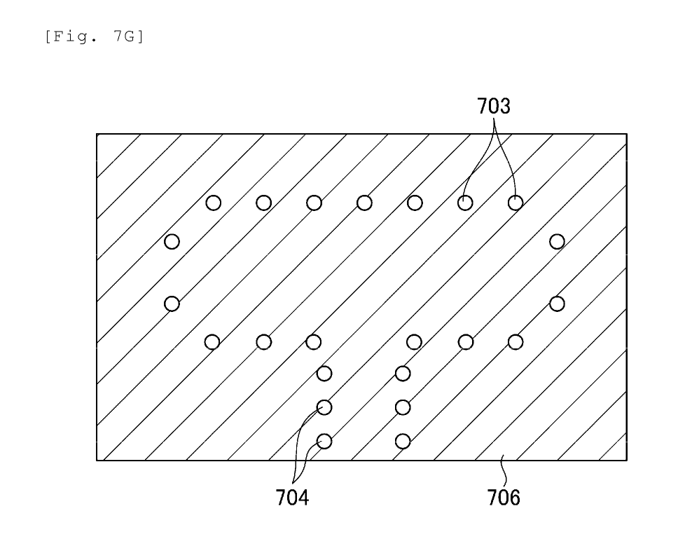

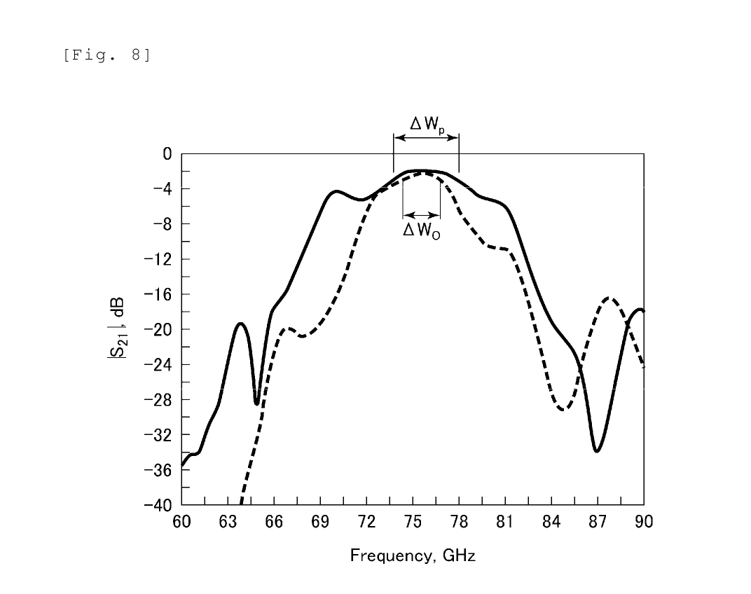

In FIGS. 7A to 7G, further another exemplary embodiment of a wideband transition between a planar transmission line segment 705 and a waveguide section 711 is presented.

FIG. 7A is a horizontal cross-section view of a wideband transition between a planar transmission line and a waveguide of further another exemplary embodiment of the present invention on the section at conductor layer 7L1 shown in FIG. 7B. FIG. 7B is a vertical cross-sectional view of the wideband transition of further another exemplary embodiment of the present invention shown in FIG. 7A on 7B-7B section. FIG. 7C is a vertical cross-sectional view of the wideband transition of further another exemplary embodiment of the present invention shown in FIG. 7A on 7C-7C section. FIG. 7D is a horizontal cross-sectional view of the wideband transition of further another exemplary embodiment of the present invention shown in FIG. 7A on the section at conductor layers 7L2. FIG. 7E is a horizontal cross-sectional view of the wideband transition of further another exemplary embodiment of the present invention shown in FIG. 7A on the section at conductor layers 7L3. FIG. 7F is a top view of the wideband transition of further another exemplary embodiment of the present invention shown in FIG. 7A. FIG. 7G is a bottom view of the wideband transition of further another exemplary embodiment of the present invention shown in FIG. 7A.

In this exemplary embodiment, the wideband transition is formed in a substrate including four conductor planes 706, which are respectively arranged in four conductor layers 7L1, 7L2, 7L3 and 7L4, stacked from top to bottom and isolated from each other by a substrate filling material 710.

In the presented exemplary embodiment shown in FIGS. 7A to 7G, the wideband transition includes a conductor patch 701, an isolating slit 702, a plurality of ground vias 703 of the wideband transition, a plurality of ground vias 704 of the planar transition line segment 705, two sets of two adjusting conductor plates 708, separation slits 709 and an opening 712 in the waveguide section 711.

The conductor patch 701 is disposed in the top conductor layer 7L1 and connected to one end of the planar transmission line segment 705. The isolating slit 702 is disposed between the conductor patch 701 and other conductors included in the conductor plane 706 arranged in the top conductor layer 7L1. The plurality of ground vias 703 of the wideband transition are arranged through the multilayer substrate from the top conductor layer 7L1 to the bottom conductor layer 7L4, connected to the conductor planes 706 of each of conductor layers 7L1 to 7L4 and disposed around the conductor patch 701 and the isolating slit 702. The plurality of ground vias 704 of the planar transmission line segment 705 are arranged through the multilayer substrate from the top conductor layer 7L1 to the bottom conductor layer 7L4, connected to the conductor planes 706 of each of conductor layers 7L1 to 7L4 and disposed along both sides of the planar transmission line segment 705. The first set of two adjusting conductor plates 708 is disposed in the intermediate conductor layer 7L2. The second set of two adjusting conductor plates 708 is disposed in the intermediate conductor layer 7L3. The separation slits 709 are disposed to isolate four adjusting conductor plates 708 from each other and other conductors at the intermediate conductor layers 7L2 and 7L3. The opening 712 is arranged in one end of the waveguide section 711 to isolate the planar transition line segment 705 from the waveguide section 711.

In this exemplary embodiment, four adjusting conductor plates 708 disposed at the conductor layers 7L2 and 7L3 are used to control an operation bandwidth of the transition. Moreover three adjusting conductor plates 708, one of which is in the conductor layer 7L2 and two of which are in the conductor layer 7L3, have coupling sections 713 for an additional control of the operation bandwidth, especially to enhance coupling between the adjusting conductor plates 708 and other conductors in the intermediate conductor layers 7L2 and 7L3 . In each of three coupling sections 713, each of the adjusting conductor plate 708 and the conductor plane 706 has an edge with a corrugated shape and those edges with the corrugated shape are facing each other.

In the exemplary embodiment, another end of the planar transmission line segment 705 serves as a first terminal of the wideband transition. Also, the one end of the waveguide section 711 is disposed above the conductor patch 701 and connected to the conductor plane 701 of the top conductor layer 7L1 (except the opening 712) while another end of the waveguide section 711 acts as a second terminal of the wideband transition. To improve the electrical performance of the planar transmission line, ground vias 704 are used in the planar transmission line segment 705.

In the transition shown in FIGS. 7A to 7G, widening of the operation bandwidth is provided by an appropriate choice of dimensions and shapes of the adjusting conductor plates 708 and corresponding coupling sections 713.

To demonstrate advantages of transitions with an adjusting conductor plate to control an operation bandwidth, simulations of the electrical performance of characteristic transitions were carried out by the

Finite-Difference Time-Domain (FDTD) technique, which is one of the most widely-used and accurate numerical methods.

Structure of the wideband transition proposed, which was used in simulations, was similar to that shown in FIGS. 3A to 3H. Characteristic dimensions of a substrate in which the transition was designed were as following: the thickness of the substrate was 1.2 mm; the thickness was 0.04 mm in top and bottom copper conductor layers; and the thickness was 0.03 mm in intermediate conductor layers. In simulations, six copper conductor planes respectively arranged in six conductor layers were isolated by a substrate filling material with the relative permittivity of 4.0, dielectric loss tangent of 0.02, relative permeability of 1 and magnetic loss tangent of 0.

FIG. 8 is a graph showing the effect of an adjusting plate on insertion losses of atransition. FIG. 8 includes a first graph drawn with a solid line and a second graph drawn with a dot line. For both first and second graphs, the horizontal axis shows the frequency in GHz and the vertical axis shows the insertion loss (|S₂₁|-parameter) in dB.

In the first graph and the second graph of FIG. 8, insertion losses are presented for the transition in which adjusting conductor plates are used, and also for the same transition but without adjusting conductor plates, respectively. As one can see, the application of the adjusting conductor plates leads to widening the operation band of the transition. In this figure, the operation bandwidth (taken at 1 dB level) of the transition with adjusting conductor plates is

ΔWₚ≈4.3 GHz

while the bandwidth at the same level of the transition without adjusting conductor plates is

ΔWₒ≈2.6 GHz

While the present invention has been described in relation to some exemplary embodiments, it is to be understood that these exemplary embodiments are for the purpose of description by example, and not of limitation. While it will be obvious to those skilled in the art upon reading the present specification that various changes and substitutions may be easily made by equal components and art, it is obvious that such changes and substitutions lie within the true scope and spirit of the presented invention as defined by the claims.

1. A wideband transition between a planar transmission line and a waveguide, comprising:
a substrate including a plurality of conductor planes which are respectively arranged in a plurality of conductor layers, stacked from top to bottom and isolated from each other by an substrate filling material;
a segment of said planar transmission line arranged in a top conductor layer of said substrate;
a conductive patch arranged in said top conductor layer and connected to one end of said segment of said planar transmission line;
an isolating slit disposed between said conductive patch and a conductor plane at said top conductor layer;
an adjusting conductor plate arranged in said top conductor layer or another conductor layer of said substrate next to said top conductor layer and isolated from any other conductor;
a plurality of ground vias arranged through said substrate from said top conductor layer to a bottom conductor layer, connected to each of said plurality of conductor planes and disposed around said conductor patch and said isolating slit;
a section of said waveguide disposed above said conductive patch and connected to said conductor plane at said top conductor layer; and
an opening arranged in one end of said section of said waveguide to isolate said segment of said planar transition line from said waveguide,
wherein another end of said segment of said planar transition line is a first terminal of said wideband transition, and
wherein another end of said section of said waveguide is a second terminal of said wideband transition.

2. The wideband transition according to claim 1,
wherein said adjusting conductor plate is arranged in said another conductor layer,
further comprising a separation slit disposed to isolate said adjusting conductor plate from any other conductor in said another conductor layer.

3. The wideband transition according to claim 2 further comprising a coupling section arranged in said another conductor layer and configured to enhance coupling between said adjusting conductor plate and other conductors in said another conductor layer,
wherein said coupling section comprises:
a first edge of said adjusting conductor plate with a corrugated shape; and
a second edge of said conductor plane in said another conductor layer with a corrugated shape, and
wherein said first edge and said second edges are facing each other.

4. The wideband transition according to claim 2 further comprising:
another adjusting conductor plate, arranged in further another conductor layer of said substrate next to said another conductor layer; and
another separation slit disposed to isolate said another adjusting conductor plate from any other conductor in said further another conductor layer.

5. The wideband transition according to claim 4 further comprising a plurality of coupling sections arranged in said another conductor layer and said further another conductor layer and configured to enhance coupling between said adjusting conductor plates and other conductors in said another conductor layer and said further another conductor layer,
wherein each of said plurality of coupling section comprises:
a first edge of said adjusting conductor plate or said another adjusting conductor plate with a corrugated shape; and
a second edge of said conductor plane in said another conductor layer or said further another conductor layer with a corrugated shape, and
wherein said first edge and said second edges in said each coupling section are facing each other.

6. The wideband transition according to claim 4, further comprising:
an additional adjusting conductor plate disposed in said top conductor layer, connected to said conductor plane at said top conductor layer and isolated from said conductive patch by said isolating slit.

7. The wideband transition according to claim 2 further comprising another adjusting conductor plate disposed in said another conductor layer and isolated from any other conductor in said another conductor layer by said separation alit.

8. The wideband transition according to claim 2 further comprising a coupling aperture disposed in further another conductor layer of said substrate next to said another conductor layer and under said conductor patch.

9. The wideband transition according to claim 7 further comprising:
a first coupling section arranged in said another conductor layer and configured to enhance coupling between said adjusting conductor plate and other conductors in said another conductor layer;
a set of two adjusting conductor plates disposed in further another conductor layer of said substrate next to said another conductor layer;
another separation slit disposed in said further another conductor layer to isolate each adjusting conductor plate of said set from any other conductor in said further another conductor layer;
a second coupling section arranged in said further another conductor layer and configured to enhance coupling between a first adjusting conductor plate of said set and other conductors in said further another conductor layer; and
a third coupling section arranged in said further another conductor layer and configured to enhance coupling between a second adjusting conductor of said set and other conductors in said further another conductor layer,
wherein each of said first, said second and said third coupling sections comprises:
a first edge of said adjusting conductor plate, said first adjusting conductor plate of said set or said second adjusting conductor plate of said set, with a corrugated shape; and
a second edge of said conductor plane in said another conductor layer or said further another conductor layer, with a corrugated shape, and
wherein said first edge and said second edges are facing each other.

10. The wideband transition according to claim 1 further comprising a coupling aperture disposed in said another conductor layer and under said conductor patch,
wherein said adjusting conductor plate is arranged in said top conductor layer and isolated from any other conductor in said top conductor layer by said isolating slit.

11. The wideband transition according to claim 3 further comprising a coupling aperture disposed in further another conductor layer of said substrate next to said another conductor layer and under said conductor patch.

12. The wideband transition according to claim 7 further comprising a coupling aperture disposed in further another conductor layer of said substrate next to said another conductor layer and under said conductor patch.
